(19) United States
(12) Patent Application Publication
(10) Pub. No.: US 2026/0125970 A1
(43) Pub. Date: May 7, 2026

(54) ARTIFICIAL GRAVEL PACK FOR A HIGH-TEMPERATURE GEOTHERMAL WELL

(71) Applicant: EnhancedGEO Holdings, LLC, Tampa, FL (US)

(72) Inventors: Kimberly C. Conner, Dexter, ME (US); Greg Lindberg, Thonotosassa, FL (US)

(21) Appl. No.: 19/377,612

(22) Filed: Nov. 3, 2025

Related U.S. Application Data
(60) Provisional application No. 63/714,969, filed on Nov. 1, 2024.

(51) Int. Cl. E21B 43/04; F24T 10/00; F24T 10/30

(52) U.S. Cl. CPC E21B 43/04; F24T 10/30; F24T 2010/50

(57) ABSTRACT

An improved geothermal system. The system includes a wellbore extending from a surface at least partially into an underground magma reservoir. The wellbore includes a plurality of manufactured gravel pieces positioned within the wellbore to form a reinforced volume. The plurality of manufactured gravel pieces configured to aid in preventing collapse of the wellbore at least in the reinforced volume.

### RELATED APPLICATIONS

The present disclosure claims priority to U.S. Provisional Patent Application Ser. No. 63/714,969, filed Nov. 1, 2024, the entirety of which is incorporated herein by reference in its entirety for all purposes.

### TECHNICAL FIELD

The present disclosure relates generally to geothermal systems and their operations, and more particularly to an artificial gravel pack for a high-temperature geothermal well.

### BACKGROUND

Solar power and wind power are commonly available sources of renewable energy, but both can be unreliable due to changes in availability and can have relatively low power densities. In contrast, geothermal energy can have a high power density and can operate under any weather conditions and at any time of day. There exists a need for improved geothermal energy technology to achieve these benefits.

### SUMMARY

This disclosure presents an artificial, or manufactured, gravel pack that facilitates maintenance of high-temperature geothermal wellbores, such as those that extend into a magma reservoir, such as a dike, sill, or other magmatic formation. This disclosure recognizes that the internal stress, or hoop stress encountered in such wellbores can be high, resulting in a need to reinforce the wellbore to help prevent against well collapse. One potential approach to reinforcing a well may is to case the wellbore. However, the establishment of such a casing can be costly and may also create a barrier to heat transfer, also be particularly challenging in the high-temperature and caustic environments of the magma wellbores described in this disclosure. The specially designed artificial gravel material described in this disclosure may help overcome these previously unrecognized challenges associated with high-temperature magma wellbores by providing a temperature resilient packing material that is specially designed to pack in a manner that facilitates flow of heat transfer fluid through the well while also effectively reinforcing the wellbore. In this way, the wellbore can be structurally reinforced while a large free volume is retained for the flow of fluid for geothermal processes. The material used to form the artificial gravel may have a high thermal conductivity, such that heat transfer is improved between this fluid and a geothermal heat

The geothermal systems of this disclosure may harness a geothermal resource with sufficiently high amounts of energy from magmatic activity such that the geothermal resource does not degrade significantly over time. This disclosure illustrates improved tools in the form of a specially engineered gravel that improves well stability and facilitates the capture of energy from high-temperature wellbores. Such wellbores may extend into magma reservoirs, such as dikes, sills, and other magmatic formations, which are significantly higher in temperature than heat sources that are accessed using conventional geothermal technologies and that can have an order of magnitude higher energy density than was available to conventional geothermal technologies. In some cases, the present disclosure can facilitate the establishment of wellbores that a more robust with less complex and costly processes, such as those used to establish a well casing in a high-temperature and/or caustic environment of a magma reservoir. This can significantly decrease well production complexity and costs, while potentially improving efficient thermal transfer.

Certain embodiments may include none, some, or all of the above technical advantages. One or more technical advantages may be readily apparent to one skilled in the art from figures, description, and claims included herein.

### BRIEF DESCRIPTION OF THE FIGURES

For a more complete understanding of the present disclosure, reference is now made to the following description, taken in conjunction with the accompanying drawings and detailed description, in which like reference numerals represent like parts.

FIG. 1 is a diagram of underground regions near a tectonic plate boundary in the Earth.

FIG. 2 is a diagram of a conventional geothermal system.

FIG. 3 is a diagram of an example improved geothermal system of this disclosure.

FIG. 4 is a diagram of the example wellbore region of FIG. 3 near the terminal end of the wellbore, which is under a high hoop stress, which may destabilize the wellbore.

FIG. 4A illustrates a diagram of the expanded region of FIG. 4 with a conceptual representation of the hoop stress that the solid rock layer formed around the wellbore can cause on the wellbore.

FIG. 5 is a diagram of the region of the wellbore shown in FIG. 3 with an open-Attorney ended fluid conduit present to provide heat transfer fluid into the wellbore and artificial gravel positioned to reinforce the wellbore and enhance heat transfer.

FIG. 6 is a diagram of the region of the wellbore shown in FIG. 3 with a closed-loop fluid conduit positioned to facilitate heat transfer between a heat transfer fluid in the fluid conduit and the geothermal heat source.

FIG. 7 is a diagram of the closed-loop arrangement of FIG. 6 with artificial gravel positioned to further reinforce the wellbore and enhance heat transfer with the geothermal heat source.

FIG. 8A is a diagram of an example barbell-shaped artificial gravel that can be used as the artificial gravel of FIGS. 5 and 7.

FIG. 8B is a diagram illustrating the nesting of two pieced of the example artificial gravel of FIG. 8A.

FIGS. 9A and 9B are diagrams of another example artificial gravel that can be used as the artificial gravel of FIGS. 5 and 7 from different perspectives.

FIG. 10 is a diagram of another example artificial gravel that can be used as the artificial gravel of FIGS. 5 and 7.

FIG. 11 is a diagram of another example artificial gravel that can be used as the artificial gravel of FIGS. 5 and 7.

FIG. 12A is a diagram of another example artificial gravel that can be used as the artificial gravel of FIGS. 5 and 7.

FIG. 12B is a diagram of a cross-section of the artificial gravel of FIG. 12A taken along the central plane illustrated in FIG. 12A.

FIG. 13A is a diagram of an example piece that can be twisted to form the example artificial gravel shown in FIGS. 13B, 13C, 13D, and 13E.

FIGS. 13B and 13C are diagrams of an example artificial gravel that can be formed from the piece of FIG. 13A and that can be used as the artificial gravel of FIGS. 5 and 7.

FIGS. 13D and 13E are diagrams of another example artificial gravel that can be formed from the piece of FIG. 13A and that can be used as the artificial gravel of FIGS. 5 and 7.

FIG. 14 is an example of a chain-link artificial gravel that can be used as the artificial gravel of FIGS. 5 and 7.

FIG. 15A is an example link that can be used in the chain-link artificial gravel of FIG. 14.

FIG. 15B is an example twisted link that can be used in the chain-link artificial gravel of FIG. 14.

### DETAILED DESCRIPTION

Embodiments of the present disclosure and its advantages will become apparent from the following detailed description when considered in conjunction with the accompanying figures. In the figures, each identical, or substantially similar component that is illustrated in various figures is represented by a single numeral or notation. For purposes of clarity, not every component is labeled in every figure, nor is every component of each embodiment shown where illustration is not necessary to allow those of ordinary skill in the art to understand the disclosure.

As used herein, “magma” refers to extremely hot liquid and semi-liquid rock under the Earth's surface. Magma is formed from molten or semi-molten rock mixture found typically between 1 km to 10 km under the surface of the Earth. However, magma can be found at shallower depths in some cases. As used herein, “borehole” refers to, including oil, gas, water, or heat from below the surface of the Earth. As used herein, a “wellbore” refers to a borehole either alone or in combination with one or more other components disposed within or in connection with the borehole. In some cases, the terms “wellbore” and “borehole” are used interchangeably. As used herein, “heat transfer fluid” refers to a fluid, e.g., a gas or liquid, that takes part in heat transfer by serving as an intermediary in cooling on one side of a process, transporting and storing thermal energy, and heating on another side of a process. Heat transfer fluids are used in processes involving heating or cooling.

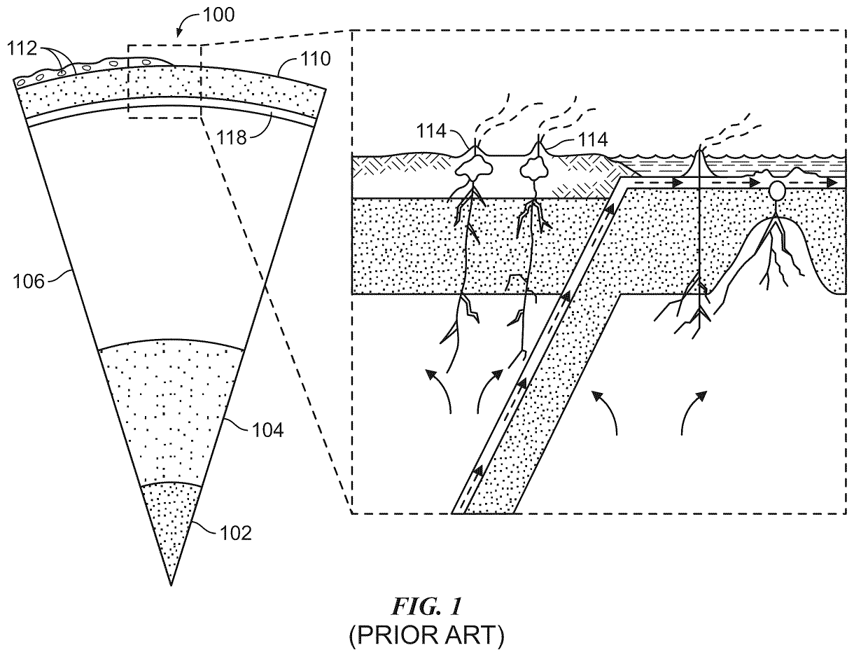

FIG. 1 is a partial cross-sectional diagram 100 of the Earth depicting underground formations that can be tapped by geothermal systems of this disclosure (e.g., for generating geothermal power). The Earth is composed of an inner core 102, outer core 104, lower mantle 106, transitional region 108, upper mantle 110, and crust 112. There are places on the Earth where magma reaches the surface of the crust 112 forming volcanoes 114. However, in most cases, magma approaches only within a few miles or less from the surface. This magma can heat ground water to temperatures sufficient for certain geothermal power production. However, for other applications, such as geothermal energy production, more direct heat transfer with magma is desirable.

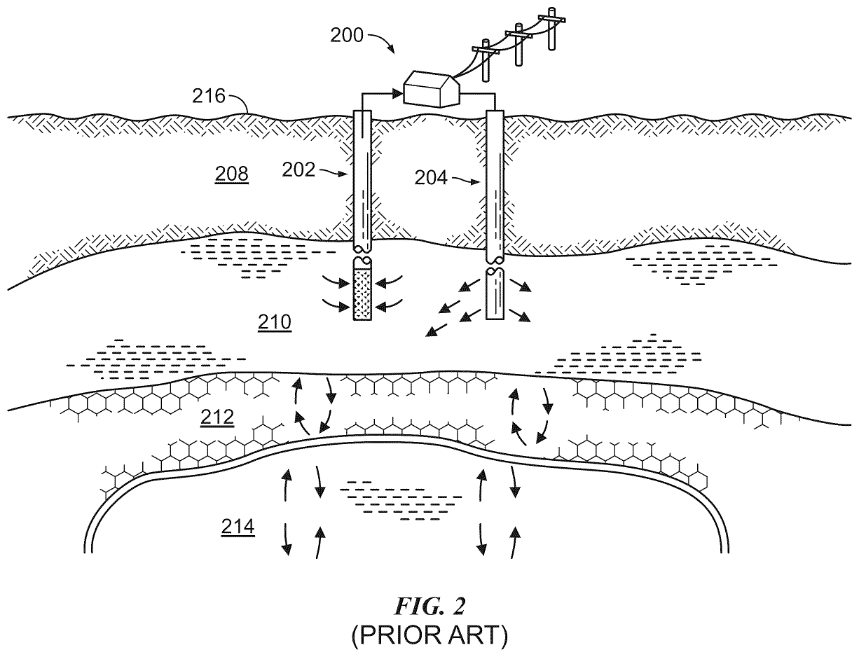

FIG. 2 illustrates a conventional geothermal system 200 that harnesses energy from heated ground water for power generation. The conventional geothermal system 200 is a “flash-plant” that generates power from a high-temperature, high-pressure geothermal water extracted from a production well 202. The production well 202 is drilled through rock layer 208 and into the hydrothermal layer 210 that serves as the source of geothermal water. The geothermal water is heated indirectly via heat transfer with intermediate layer 212, which is in turn heated by magma reservoir 214. Magma reservoir 214 can be any underground region containing magma such as a dike, sill, or the like. Convective heat transfer (illustrated by the arrows indicating that hotter fluids rise to the upper portions of their respective layers before cooling and sinking, then rising again) may facilitate heat transfer between these layers. Geothermal water from the hydrothermal layer 210 flows to the surface 216 and is used for geothermal power generation. The geothermal water (and possibly additional water or other fluids) is then injected back into the hydrothermal layer 210 via an injection well 204.

The configuration of conventional geothermal system 200 of FIG. 2 suffers from drawbacks and disadvantages, as recognized by this disclosure. For example, because geothermal water is a multicomponent mixture (i.e., not pure water), the geothermal water flashes at various points along its path up to the surface 216, creating water hammer, which results in a large amount of noise and potential damage to system components. The geothermal water is also prone to causing scaling and corrosion of system components. Chemicals may be added to partially mitigate these issues, but this may result in considerable increases in operational costs and increased environmental impacts, since these chemicals are generally introduced into the environment via injection well 204.

### Example Magma-based Geothermal System

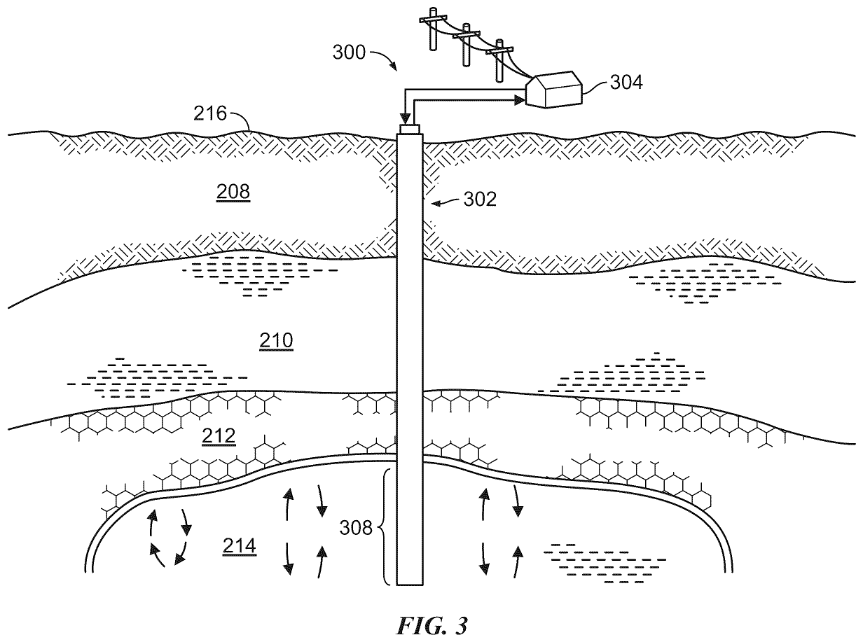

FIG. 3 illustrates an example magma-based geothermal system 300 of this disclosure. The magma-based geothermal system 300 includes a wellbore 302 that extends from the surface 216 at least partially into the magma reservoir 214. A heat exchanger may be located inside the wellbore 302. The magma-based geothermal system 300 is a closed system in which a heat transfer fluid is provided down the wellbore 302 to be heated and returned to a thermal process system 304 (e.g., for power generation and/or any other thermal processes of interest). As such, geothermal water is not extracted from the Earth, resulting in significantly reduced risks associated with the conventional geothermal system 200 of FIG. 2, as described further below. Heated heat transfer fluid is provided to the thermal process system 304. The thermal process system 304 is generally any system that uses the heat transfer fluid to drive a process of interest. For example, the thermal process system 304 may include an electricity generation system and/or support thermal processes requiring higher temperatures/pressures than could be reliably or efficiently obtained using previous geothermal technology, such as the conventional geothermal system 200 of FIG. 2.

Heat transfer fluid used in the geothermal system 300 may be any appropriate fluid for absorbing heat within the wellbore 302 and driving operations of the thermal process system 304. For example, the heat transfer fluid may include water, a brine solution, one or more refrigerants, a thermal oil (e.g., a natural or synthetic oil), a silicon-based fluid, a molten salt, a molten metal, or a nanofluid (e.g., a carrier fluid containing nanoparticles). A molten salt is a salt that is a liquid at the high operating temperatures experienced in the wellbore 302 (e.g., at temperatures between 1,600 and 2,300 °F.). In some cases, an ionic liquid may be used as the heat transfer fluid. An ionic liquid is a salt that remains a liquid at more modest temperatures (e.g., at or near room temperature). In some cases, a nanofluid may be used as the heat transfer fluid. The nanofluid may be a molten salt or ionic liquid with nanoparticles, such as graphene nanoparticles, dispersed in the fluid. Nanoparticles have at least one dimension of 100 nanometers (nm) or less. The nanoparticles increase the thermal conductivity of the molten salt or ionic liquid carrier fluid. This disclosure recognizes that molten salts, ionic liquids, and nanofluids can provide improved performance as heat transfer fluids in the wellbore 302. For example, molten salts and/or ionic liquids may be stable at the high temperatures that can be reached in the wellbore 302. The high temperatures that can be achieved by these materials not only facilitate increased energy extraction but also can drive thermal processes that were previously inaccessible using previous geothermal technology. The heat transfer fluid may be selected at least in part to limit the extent of corrosion of surfaces of the geothermal system 300 and/or the artificial gravel (described further below). As an example, the heat transfer fluid may be water. The water is supplied to the wellbore 302 as stream of heat transfer fluid in the liquid phase and is transformed into steam within the wellbore 302. The steam is used to drive operations of the thermal process system 304.

The magma-based geothermal system 300 provides technical advantages over previous geothermal systems, such as the conventional geothermal system 200 of FIG. 2. The magma-based geothermal system 300 can achieve higher temperatures and pressures for increased energy generation and/or for more effectively driving other thermal processes, such as for fuel production. For example, because of the high energy density of magma in magma reservoir 214 (e.g., compared to that of geothermal water of the geothermal fluid layer 210), wellbore 302 can generally create the power of many wells of the conventional geothermal system 200 of FIG. 2. Furthermore, the heat transfer fluid is generally not substantially released into the geothermal zone, resulting in a decreased environmental impact and decreased use of costly materials (e.g., chemical additives that are used and introduced to the environment in great quantities during some conventional geothermal operations). The magma-based geothermal system 300 may also have a simplified design and operation compared to those of previous systems. For instance, fewer components and reduced complexity may be needed at the thermal process system 304 because only relatively clean heat transfer fluid (e.g., steam) reaches the surface 216. There may be no need or a reduced need to separate out solids or other impurities that are common to geothermal water. The example magma-based geothermal system 300 may include further components not illustrated in FIG. 3.

Further details and examples of different configurations of geothermal systems and methods of their preparation and operation are described in U.S. patent application Ser. No. 18/099,499, filed Jan. 20, 2023, and titled “Geothermal Power from Superhot Geothermal Fluid and Magma Reservoirs”; U.S. patent application Ser. No. 18/099,509, filed Jan. 20, 2023, and titled “Geothermal Power from Superhot Geothermal Fluid and Magma Reservoirs”; U.S. patent application Ser. No. 18/099,514, filed Jan. 20, 2023, and titled “Geothermal Power from Superhot Geothermal Fluid and Magma Reservoirs”; U.S. patent application Ser. No. 18/099,518, filed Jan. 20, 2023, and titled “Geothermal Power from Superhot Geothermal Fluid and Magma Reservoirs”; U.S. patent application Ser. No. 18/105,674, filed Feb. 3, 2023, and titled “Wellbore for Extracting Heat from Magma Chambers”; U.S. patent application Ser. No. 18/116,693, filed Mar. 2, 2023, and titled “Geothermal Systems and Methods with an Underground Magma Chamber”; U.S. patent application Ser. No. 18/116,697, filed Mar. 2, 2023, and titled “Method and System for Preparing a Geothermal System with a Magma Chamber”; U.S. patent application Ser. No. 18/195,810, filed May 10, 2023, and titled “Reverse-Flow Magma-Based Geothermal Generation”; U.S. patent application Ser. No. 18/195,814, filed May 10, 2023, and titled “Partially Cased Wellbore in Magma Reservoir”; U.S. patent application Ser. No. 18/195,822, filed May 10, 2023, and titled “Geothermal System With a Pressurized Chamber in a Magma Wellbore”; U.S. patent application Ser. No. 18/195,828, filed May 10, 2023, and titled “Magma Wellbore With Directional Drilling”; U.S. patent application Ser. No. 18/195,837, filed May 10, 2023, and titled “Molten Salt as Heat Transfer Fluid in Magma Geothermal System”; and U.S. patent application Ser. No. 18/141,326, filed Feb. 28, 2023, and titled “Casing a Wellbore in Magma”, the entirety of each of which is hereby incorporated by reference.

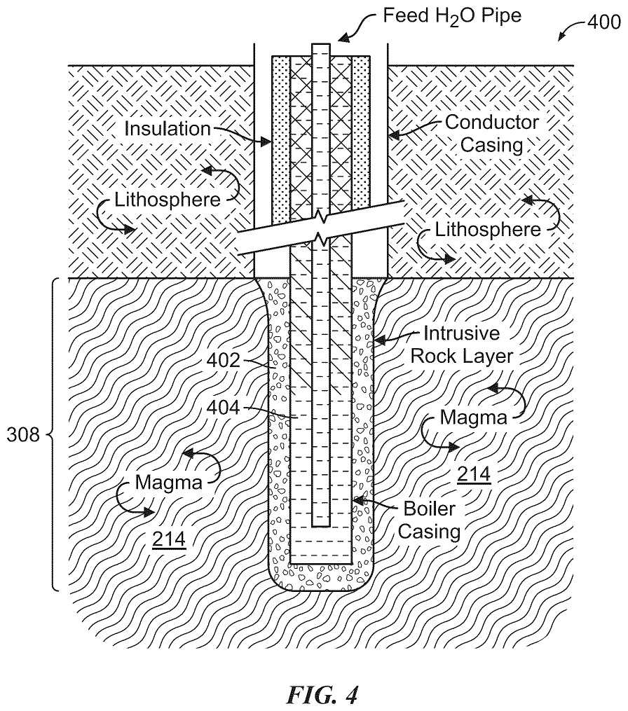

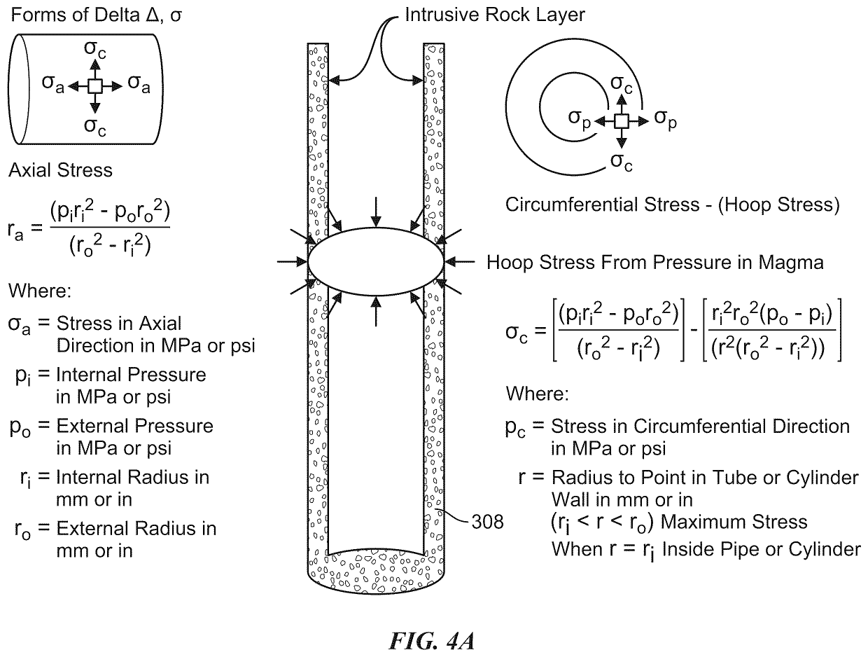

Still referring to FIG. 3, region 308 shown in FIG. 3 is a portion of the wellbore 302 that extends into the magma reservoir 214. This disclosure recognizes that region 308 is uniquely susceptible to a high hoop stress. FIG. 4 shows a diagram 400 of an expanded view of region 308 in a scenario in which the wellbore 302 is filled with a heat transfer fluid 404. Heat transfer fluid 404 may be any appropriate fluid, such as water, drilling mud, or any of the heat transfer fluids described above with respect to FIG. 3. A solid layer 402 is formed by quenching magma in the magma reservoir 214. If a conventional heat transfer fluid 404 is used, the internal pressure (Pᵢ) within the wellbore 302 is generally much less than the outer pressure (Pₒ) in the magma reservoir 214. This can result in instability of the solid layer 402 over time, particularly if the wellbore 302 is uncased in this region (region 308 of FIG. 3). FIG. 4A illustrates a diagram of the expanded region 308 of FIG. 4 with a conceptual representation of the hoop stress that the solid rock layer 402 formed around the wellbore can cause on the wellbore. As conventional wellbores do not extend into magma reservoirs, these problems were generally unrecognized prior to this disclosure.

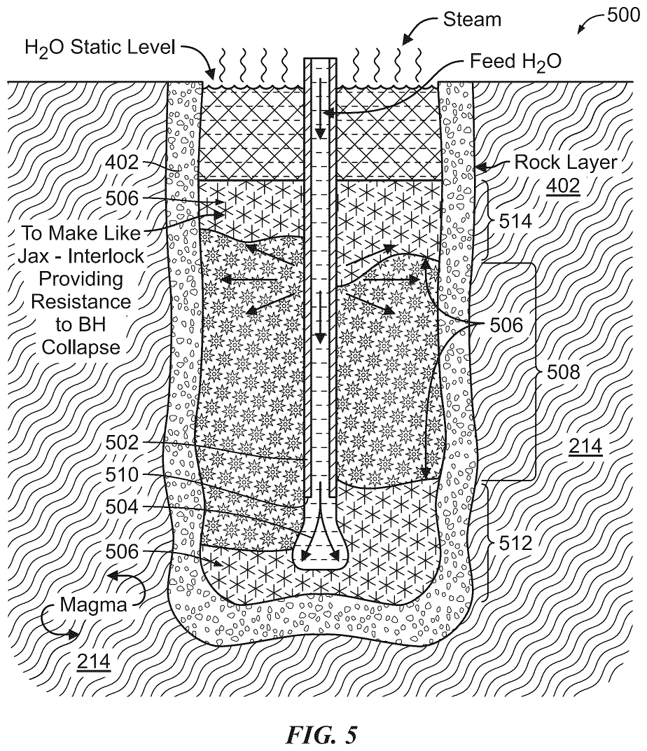

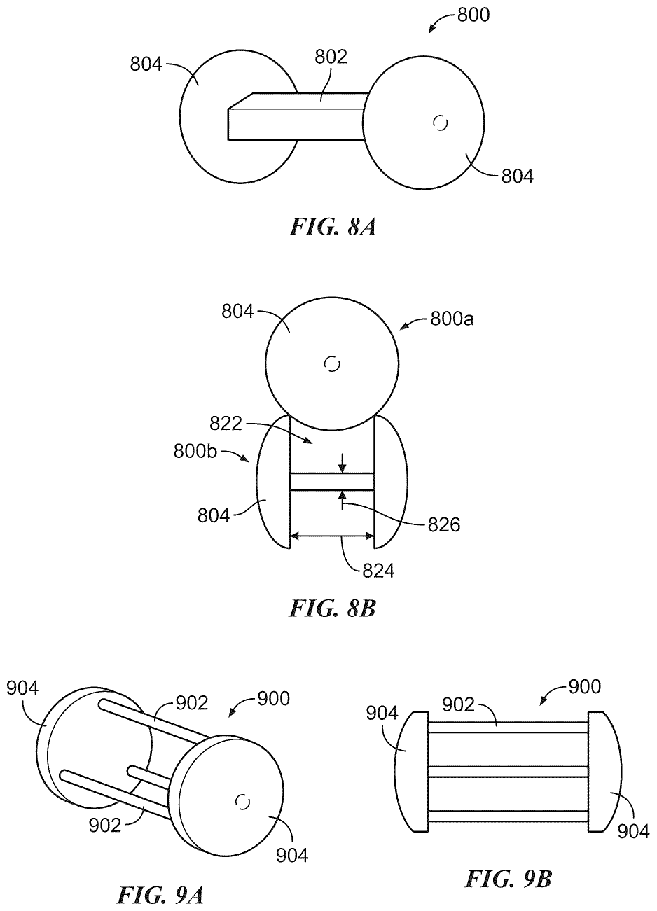

As explained in greater detail below, rather than casing the wellbore 302 (or in addition to casing the wellbore 302, for example, if such casing does not provide adequate stability, specially manufactured artificial gravel of this disclosure can be positioned within the wellbore 302 (or within the heat exchanger positioned within the wellbore) to reinforce the wellbore 302 in region 308 and improve structural stability of the wellbore 302. For example, artificial gravel pieces may be positioned to reinforce at least a portion of the volume of the wellbore 302 in region 308. The artificial gravel aids in preventing collapse of the wellbore 302 at least in this reinforced volume. FIGS. 5, 6 and 7 show examples of the wellbore 302 when reinforced. The remaining FIGS. 8A-15B show examples of different artificial or manufactured gravel pieces.

### Example Reinforced Geothermal Systems

FIG. 5 is a diagram 500 of region 308 of FIG. 3 in which an open-ended fluid conduit 502 is positioned to allow a flow of heat transfer fluid 504 into the wellbore 302. The open-ended fluid conduit 502 (also referred to as an “open fluid conduit”) transports heat transfer fluid 504 toward the terminal end 510 of the wellbore 302 and releases the heat transfer fluid 504 into the wellbore 302, as shown by the arrows in FIG. 5. The heat transfer fluid 504 may be any appropriate fluid, including, but not limited to, any of the heat transfer fluids described above with respect to FIG. 3.

Artificial gravel 506 is positioned to form one or more packs that reinforce the wellbore 302 and that may enhance heat transfer. The artificial gravel 506 may be arranged as shown in FIG. 5 or in any other suitable arrangement to help reinforce the wellbore 302. The artificial gravel 506 may be formed of a heat conducting material. For example, the artificial gravel 506 may be made of or may contain steel, other metal(s), high-conductivity ceramic(s), and/or the like. As shown in the example of FIG. 5, at least a portion of the pieces of artificial gravel 506 contact an inner surface of the wellbore 302 (e.g., by contacting the solid layer 402), thereby facilitating increased heat transfer with the magma reservoir 214.

The pieces of artificial gravel 506 may provide or improve stability via establishing a continuous, or nearly continuous, physical support across the diameter of the wellbore 302 near the terminal end 510. Similarly, stability may be provided or improved by forming a continuous, or nearly continuous, physical support structure from the wall of the wellbore 302 (e.g., solid surface 402) and the outer wall of the fluid conduit 502. For example, a portion of the pieces of artificial gravel 506 may contact an inner surface of the wellbore 302, while another portion of the pieces of artificial gravel 506 contact an outer surface of the open-ended fluid conduit 502. This arrangement helps to stabilize the inner surface of the wellbore 302, while also facilitating increased heat transfer between the inner surface of the wellbore 302 (which is in proximity to the magma reservoir 214) and the outer surface of the open-ended fluid conduit 502.

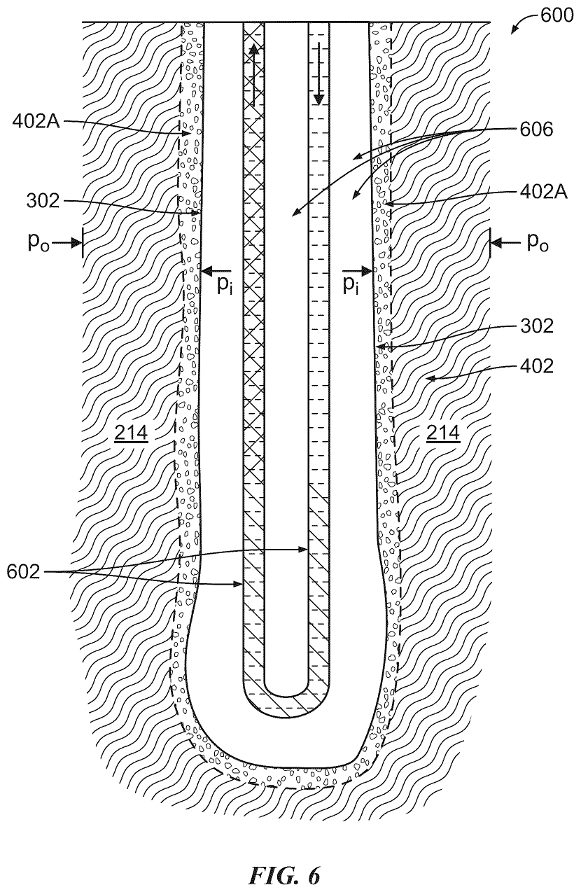

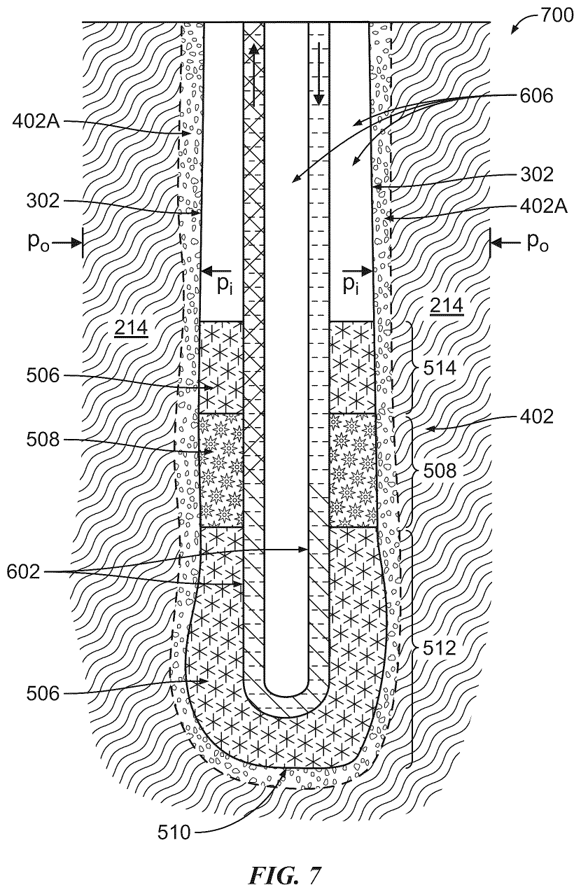

As described further below with respect to the example artificial gravel pieces of FIGS. 7A-15B, the pieces of artificial gravel 506 may be configured or structured to interlock with each other, such that the pieces of artificial gravel 506 form an interlocked structure within the wellbore 302. Different possible interlocking shapes of the artificial gravel 506 are described below with respect to FIGS. 7A-15B. In the example of FIG. 5 in which the heat transfer fluid 504 enters the annular space between the solid layer 402 and the fluid conduit 502, the interlocked structure of the artificial gravel 506 forms an empty volume through which the heat transfer fluid 504 can flow (see, e.g., an empty volume formed by empty space 822 of FIG. 8B).

In the example of FIG. 5, artificial gravel 506 is positioned, or packed, to create a first reinforced volume 512 near the terminal end 510 of the wellbore 302 and a second reinforced volume 514 higher up in the wellbore 302. The artificial gravel 506 aids in preventing collapse of the wellbore 302 at least in these reinforced volumes 512, 514 and may provide improved overall stability to the wellbore 302.

The artificial gravel 506 may be placed in reinforced volume 512 by allowing the pieces of artificial gravel 506 to sink to the bottom of the wellbore 302. After placement of pieces of artificial gravel 506 to establish reinforced volume 512, a permeable packer 508 may be positioned in the wellbore 302 to hold subsequently added artificial gravel 506 in the higher reinforced volume 514. The permeable packer 508 is permeable to the flow of heat transfer fluid 504, while still being suitable for holding the pieces of artificial gravel 506 in place. As an example, the permeable packer 508 may be made of a steel mesh or other suitably strong material with elastic sealing elements to seal the annular space between the fluid conduit 502 and the inner wall of the wellbore 302. Unlike a conventional packer, the permeable packer 508 does not fluidically isolate an upper and lower region of the wellbore 302. Instead, the unique permeable packer 508 of this disclosure holds the pieces of artificial gravel pieces 506 in a desired position to provide adequate reinforcement/fortification to selected regions of the wellbore 302, such as in reinforced volume 514 in the example of FIG. 5.

In an example operation of the configuration shown in diagram 500, heat transfer fluid 504 flows through the open-ended fluid conduit 502 along the flow path shown by the arrows in conduit 502. The heat transfer fluid 504 is then released into the wellbore 302 (see arrows 504 in FIG. 5) where it is heated via heat transfer with the geothermal heat source (i.e., the magma reservoir 214 in this example). This heat transfer is facilitated via heat transfer through the solid rock layer 402 and via heat transfer through the artificial gravel 506. Artificial gravel 506 with a high thermal conductivity may aid in heating the heat transfer fluid 504 by providing an increased surface area that is at an elevated temperature and that contacts the heat transfer fluid 504. Heated heat transfer fluid 504 is returned to the surface via the annular space between the inner wall of the wellbore 302 and the outer wall of the open-ended conduit 502. In some cases, the direction of flow may be reversed, such that the heat transfer fluid 504 flows down this annular space and returns to the surface via the open-ended fluid conduit 502 (i.e., with the arrows in FIG. 5 reversed).

FIG. 6 is a diagram 600 of region 308 of FIG. 3 in which a closed fluid conduit 602 is positioned to allow transport of heat transfer fluid 604 toward the terminal end 510 of the wellbore 302 and return the heat transfer fluid 504 heated in the wellbore 302 back to the surface without releasing the heat transfer fluid 604 into the wellbore 302 (see arrows in closed conduit 602 of FIG. 6). The heat transfer fluid 604 may be any appropriate fluid, including, but not limited to, any of the heat transfer fluids described above with respect to FIG. 3.

In the example of FIG. 6, the wellbore 302 contains a secondary heat transfer fluid 606. The secondary heat transfer fluid 606 may improve heat transfer between the heat transfer fluid 604 in closed conduit 602 and the heat source (i.e., the magma reservoir 214 in this example). The secondary heat transfer fluid 606 can generally be any heat transfer fluid as described above or as known in the art. However, in some cases, the secondary heat transfer fluid 606 is a fluid with a high thermal conductivity (e.g., relative to the thermal conductivity of water). In some cases, the secondary heat transfer fluid 606 is a fluid with a high density (e.g., relative to the density of water). The use of a high density secondary heat transfer fluid 606 may aid in stabilizing and reinforcing the wellbore 302 through an increase in the internal pressure (Pᵢ) in the wellbore 302. In some cases, the secondary heat transfer fluid 606 is a fluid with both a higher density than that of water and a higher thermal conductivity than that of water. As an example, the secondary heat transfer fluid 606 may be a eutectic salt, an ionic liquid, a nanofluid, or an oil.

In an example operation of the configuration shown in diagram 600, heat transfer fluid 604 flows through the closed fluid conduit 602 along the path shown by the arrows in conduit 602. During this time, the heat transfer fluid 604 is heated via heat transfer with the geothermal heat source (i.e., the magma reservoir 214 in this example). This heat transfer is facilitated via heat transfer through the solid rock layer 402 and via heat transfer through the secondary heat transfer fluid 606. In some embodiments, in addition to the solid rock layer 402 of cooled, hardened magma formed as the liquid magma 214 is cooled against the wellbore 302, when the magma 214 is rapidly cooled, an additional “glass” barrier 402A forms between the solid rock layer 402 and the wellbore 302 (or the boiler casing of the wellbore 302 in the embodiment of FIGS. 3-5). This glass barrier 402A is comprised of obsidian. As described above, the secondary heat transfer fluid 606 may have a relatively high thermal conductivity to help improve heating of the heat transfer fluid 604. The heated heat transfer fluid 604 is returned to the surface via conduit 602.

FIG. 7 is a diagram 700 of region 308 of FIG. 3 with the same closed fluid conduit 602 shown in FIG. 6. However, in the example of FIG. 7, artificial gravel 506 is packed in the wellbore 302 to further reinforce the wellbore 302 (e.g., in addition to any reinforcement provided through the use of a high density secondary heat transfer fluid 606). The artificial gravel 506 may be arranged as shown in FIG. 7 or in any other suitable arrangement to help reinforce the wellbore 302. In the example of FIG. 7, the artificial gravel 506 is arranged similarly to the arrangement described above with respect to FIG. 5. Namely, artificial gravel 506 is positioned to create a first reinforced volume 512 near the terminal end 510 of the wellbore 302 and a second reinforced volume 514 higher up in the wellbore 302 using a permeable packer 508. The artificial gravel 506 aids in preventing collapse of the wellbore 302 at least in these reinforced volumes 512, 514 and may provide improved overall stability and/or heat transfer in the wellbore 302.

The pieces of artificial gravel 506 may provide stability via establishing a continuous, or nearly continuous, physical support across the diameter of the wellbore 302 near the terminal end 510. Similarly, stability may be provided by forming a continuous, or nearly continuous, physical support structure from the wall of the wellbore 302 (e.g., solid surface 402) and the outer wall of the closed fluid conduit 602. In this example arrangement, one portion of the artificial gravel 506 contacts the inner surface of the wellbore 302, while another portion of the artificial gravel 506 contacts an outer surface of the closed fluid conduit 602, thereby stabilizing the inner surface of the wellbore 302, while also facilitating increased heat transfer between the inner surface of the wellbore 302 and the outer surface of the closed fluid conduit 602.

In an example operation of the configuration shown in diagram 700, heat transfer fluid 604 flows through the closed fluid conduit 602 along the path shown by the arrows in conduit 602. During this time, the heat transfer fluid 604 is heated via heat transfer with the geothermal heat source (i.e., the magma reservoir 214 in this example). This heat transfer is facilitated via heat transfer through the solid layer 402 and via heat transfer through the artificial gravel 506 and/or through the secondary heat transfer fluid 606. The artificial gravel 506 may have a high thermal conductivity, such that heat transfer is improved over the amount of heat that could be transferred in the absence of the artificial gravel 506. The heated heat transfer fluid 604 is returned to the surface via conduit 602.

### Example Artificial Gravel

### Dumb-Bell Shaped Gravel

FIG. 8A shows an example artificial gravel piece 800 that may be used as artificial gravel 506 of FIGS. 5 and 7. Artificial gravel piece 800 has a barbell-type shape with approximately hemispherical end parts 804 that are attached by a connecting rod 802. While this example, shows hemispherical end parts 804, these end parts 804 can have a different shape (e.g., spherical, rectangular, etc.). Similarly, while the example of FIG. 8, shows a cylindrical connecting rod 802, the connecting rod 802 can have any appropriate shape (e.g., with a polygonal cross section).

FIG. 8B shows how two artificial gravel pieces 800a and 800b can interlock when placed in a wellbore to provide an empty space 822 that provides a free, or empty, volume for the flow of heat transfer fluid (e.g., heat transfer fluid 504 or 506 of the examples described above) through the wellbore 302. For example, a length 824 of the connecting rod 802 may be less than the diameter 826 of the approximately hemispherical end parts 804, such that the approximately hemispherical end part 804 of one manufactured gravel piece 800b fits partially within and forms the empty space 822 between the approximately hemispherical end parts 804 of the other manufactured gravel piece 800a.

FIG. 9A and FIG. 9B show another example artificial gravel piece 900 from different perspective that may be used as artificial gravel 506 of FIGS. 5 and 7. Artificial gravel piece 900 also has a bar-bell type shape. However, in the example of FIGS. 9A and 9B, the artificial gravel piece 900 has multiple connecting rods 902 connecting the approximately hemispherical end parts 904. As with the end parts 804 of FIG. 8, the end parts 904 may have an alternative shape (e.g., spherical, rectangular, etc.) as long as this shape allows artificial gravel pieces 900 to interlock to form an empty space like space 822 of FIG. 8B that provides an empty volume for the flow of heat transfer fluid. Furthermore, the connecting rods 902 can have the cylindrical shape depicted in FIGS. 9A and 9B or any other appropriate shape.

### Jack-Type Shaped Gravel

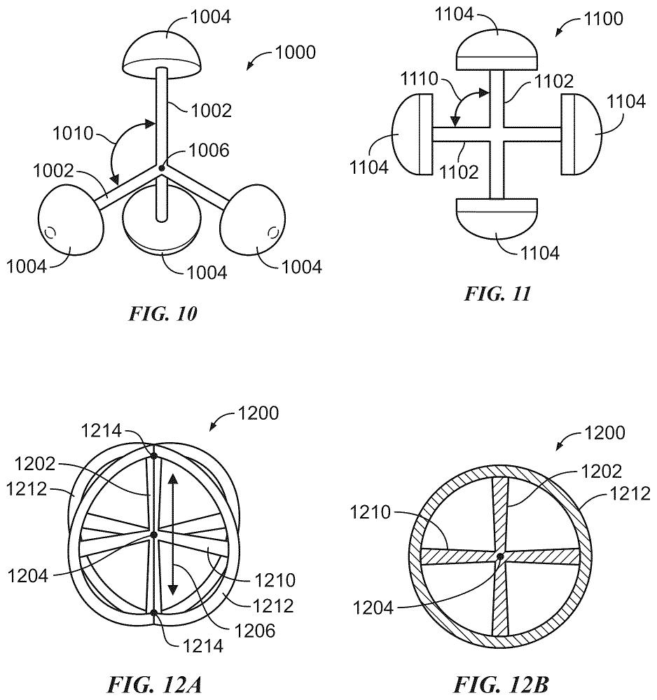

FIG. 10 shows an example artificial gravel piece 1000 that may be used as artificial gravel 506 of FIGS. 5 and 7. Artificial gravel piece 1000 is shaped similarly to a jack with four approximately hemispherical end parts 1004 each connected to a corresponding connecting rod 1002. The connecting rods 1002 are each joined on one end to their corresponding end piece 1004. Each connecting rod 1002 is then joined at its remaining end to the other connecting rods 1002 at a central point 1006. In the example of FIG. 10, three of the connecting rods 1002 extend along a plane with a regular angle 1010 between adjacent connecting rods 1002. The fourth connecting rod 1002 extends in a direction normal to the plane. While the example end pieces 1004 have an approximately hemispherical shape in the example of FIG. 10, the end pieces 1004 can have a different shape (e.g., spherical, rectangular, etc.). Likewise, while the example connecting rods 1002 are cylindrical, the connecting rods 1002 can have any appropriate shape (e.g., with a polygonal or other shape cross section).

FIG. 11 shows another example artificial gravel piece 1100 that may be used as artificial gravel 506 of FIGS. 5 and 7. Artificial gravel piece 1100 is also shaped similarly to a jack with four approximately hemispherical end parts 1104 each connected to a corresponding connecting rod 1102. The connecting rods 1102 are each joined on one end to their corresponding end piece 1104. Each connecting rod 1102 is then joined at its remaining end to the other connecting rods 1102 at a central point 1106. In the example of FIG. 11, the four connecting rods 1102 extend along the same plane with a regular angle 1110 between adjacent connecting rods 1102. While the example end pieces 1104 have an approximately hemispherical shape in the example of FIG. 11, the end pieces 1104 can have a different shape (e.g., spherical, rectangular, etc.). Likewise, while the example connecting rods 1102 are cylindrical, the connecting rods 1102 can have any appropriate shape (e.g., with a polygonal or other shape cross section).

### Round Gravel

FIG. 12A shows an example artificial gravel piece 1200 that may be used as artificial gravel 506 of FIGS. 5 and 7. Artificial gravel piece 1200 has a round shape with a central rod 1202 (e.g., an approximately cylindrical rod or cylindrical rod with a tapered diameter as shown) extending along a vertical direction 1206. The central rod 102 connects at its ends 1214 and 1216 to a number of rounded parts 1212. The rounded parts 1212 extend in an arc from the top end 1214 of the central rod 1202 to the bottom end 1216 of the central rod 1202. Each rounded part 1212 is also connected at a central (or approximately central) point 1218 to a corresponding support rod 1210 that connects the rounds part 1212 to the central rod 1202. The support rods 1210 provide structural support to the rounded parts 1212 and help hold the rounded parts 1212 to the central rod 1202. Each support rod is connected along an outer circumference of the central rod 1202 at a position 1204 along a length of the central rod 1202 (e.g., at about the center of the central rod 1202). The support rods 1210 are directed along a plane 1208 normal to the vertical direction 1206 of the central rod 1202.

FIG. 12B shows a cross-sectional view of the artificial gravel piece 1200 taken along plane 1208. This view shows that each support rod 1210 extends along the plane 1208 at an angle 1220 relative to an adjacent support rod 1210. In the example of FIGS. 12A and 12B, the artificial gravel piece 1200 has four rounded parts 1212 and four corresponding support rods 1210. However, this disclosure encompasses artificial gravel pieces that may have more or fewer rounded parts 1212 and support rods 1210.

### Twisted Rectangular Gravel

In some cases, the artificial gravel 506 may be formed by bending and/or twisting a piece of material with the desired physical and heat transfer properties. For example, artificial gravel 506 may be formed by twisting a rectangular piece of material that has an appropriate strength and thermal conductivity (e.g., steel).

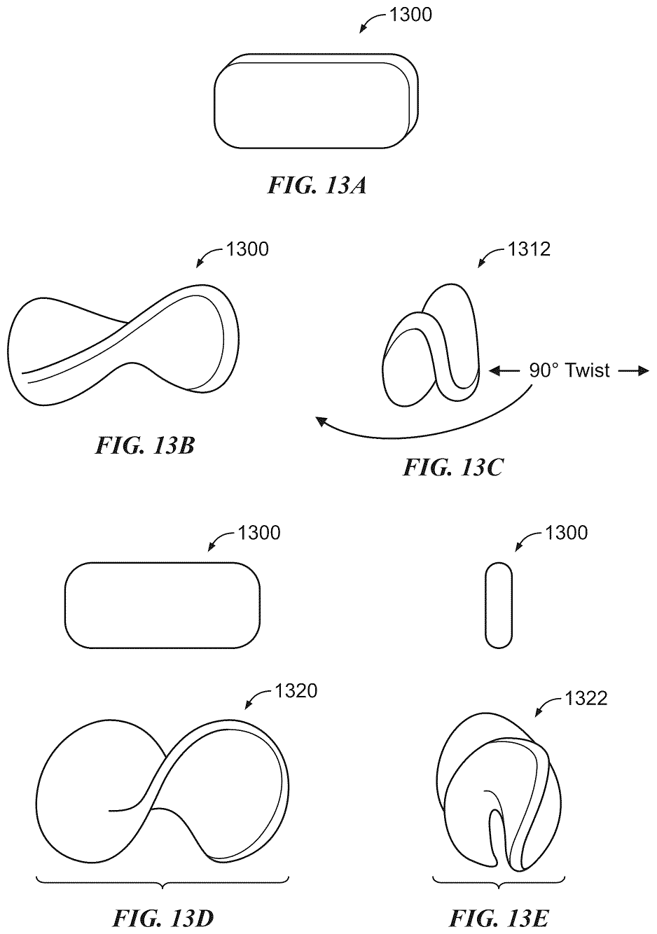

FIG. 13A shows an example of such a piece 1300 of material. FIG. 13B and FIG. 13C show an example artificial gravel piece 1310 that is formed from piece 1300 of FIG. 13A and can be used as artificial gravel 506 of FIGS. 5 and 7. FIG. 13C shows an edge-on view from perspective 1312 of the artificial gravel piece 1310 of FIG. 13B. Artificial gravel piece 1310 is the rectangular piece 1300 twisted along a central plane 1302 of the rectangular piece 1300. In the examples of FIGS. 13B and 13C, the rectangular piece is twisted at an angle of about 90 degrees.

FIG. 13D and FIG. 13E show another example artificial gravel piece 1320 that is also formed from piece 1300 of FIG. 13A and can be used as artificial gravel 506 of FIGS. 5 and 7. FIG. 13E shows an edge-on view from perspective 1322 of artificial gravel piece 1320 of FIG. 13D. Artificial gravel piece 1320 is the rectangular piece 1300 twisted along a central plane 1302 of the rectangular piece 1300. In the examples of FIGS. 13D and 13E, the rectangular piece is twisted at an angle of about 180 degrees.

When packed into the wellbore 302, the example twisted artificial gravel pieces 1310 and 1320 of FIGS. 13B-13E may form an interlocked structure with a free volume for the flow of heat transfer fluid. The example twisted artificial gravel pieces 1310 and 1320 of FIGS. 13B-13E may also be relatively simple and low-cost to prepare.

### Chain-Link Gravel

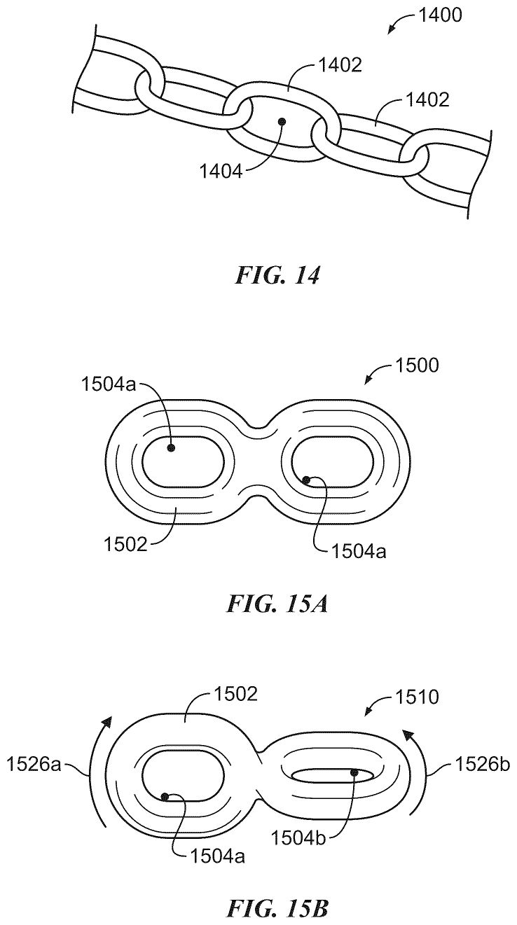

FIG. 14 shows an example chain-link artificial gravel 1400 that may be used as artificial gravel 506 of FIGS. 5 and 7. Chain-link artificial gravel 1400 is formed of connected links 1402. The links 1402 are made of a material, such as steel, with a sufficient strength to reinforce the wellbore 302 and a high thermal conductivity to improve heat transfer in the wellbore 302. Each link 1402 has at least one opening 1404 that allows connection to adjacent links 1402 and may also help facilitate formation of a free volume that allows the flow of heat transfer fluid through a volume reinformed by the chain-link artificial gravel 1400. The chain-link artificial gravel 1400 may be relatively simple to construct and place in the wellbore 302. For example, a chain formed of the chain-link artificial gravel 1400 may be lowered into the wellbore 302 to form the reinforced volumes 512, 514 shown in the examples of FIGS. 5 and 7.

In some cases, the links 1402 of the chain-link artificial gravel 1400 may be specially designed to increase the free volume that is formed when the chain-link artificial gravel 1400 is placed in the wellbore 302. FIG. 15A and FIG. 15B show examples of links 1500 and 1510, respectively, that can be used to form chain-link artificial gravel similar to chain-link artificial gravel 1400 of FIG. 14B. The example link 1500 of FIG. 15A has a solid body 1502 with two openings 1504a and 1504b. This link 1500 with two openings 1504a, b may help prevent an adjacent link attached at opening 1504a from coming into contact with an adjacent link attached at opening 1504b. In this way, chain-link artificial gravel formed from link 1500 may have less chance of fully occupying a space, such that there is an increased free volume for the flow of heat transfer fluid.

The example twisted link 1510 of FIG. 15B is the same material as link 1500 but with one opening 1504b rotated relative to the other opening 1504a. In this example, opening 1504a is in an upward direction 1526a, while opening 1504b is oriented in an angled direction 1526 b. This may be achieved by twisting the body 1502 at a central point 1522 at an angle 1524. The use of twisted link 1510 may further increase the amount of free volume available for the flow of heat transfer fluid.

### ADDITIONAL EMBODIMENTS

The following descriptive embodiments are offered in further support of the one or more aspects of this disclosure.

Embodiment 1. A system, comprising:
a wellbore extending from a surface to a terminal end within an underground magma reservoir; and
a plurality of manufactured gravel pieces positioned within a reinforced volume of the wellbore, the plurality of manufactured gravel pieces configured to aid in preventing collapse of the wellbore at least in the reinforced volume, and optionally one or more of the following features:
   wherein the wellbore is an uncased wellbore;
   wherein each of the manufactured gravel pieces is configured to interlock with another of the manufactured gravel pieces, such that the manufactured gravel pieces form an interlocked structure within the wellbore (e.g., the manufactured gravel pieces may have a toggle shape, barbell shape, jack shape, or the like);
   wherein the interlocked structure forms an empty volume within the reinforced volume through which fluid can flow;
   wherein at least a portion of the plurality of manufactured gravel pieces are located at the terminal end of the wellbore within the magma reservoir;
   wherein the system further comprises a permeable packer positioned at a position above the terminal end of the wellbore and configured to hold at least a portion of the plurality of manufactured gravel pieces in place above the permeable packer, while allowing a flow of fluid through the permeable packer;
   wherein each of the plurality of manufactured gravel pieces is formed of a heat conducting material (e.g., steel, metal, high-conductivity ceramic, etc.);
   wherein a portion of the plurality of manufactured gravel pieces contact an inner surface of the wellbore, thereby facilitating increased heat transfer with the magma reservoir;
   wherein the system further comprises an open fluid conduit configured to transport heat transfer fluid to the terminal end of the wellbore and release the heat transfer fluid into the wellbore;
   wherein a first portion of the plurality of manufactured gravel pieces contacts an inner surface of the wellbore, while a second portion of the plurality of manufactured gravel pieces contacts an outer surface of the open fluid conduit, thereby stabilizing the inner surface of the wellbore that is contacted by the first portion of the plurality of manufactured gravel pieces and facilitating increased heat transfer between the inner surface of the wellbore and the outer surface of the open fluid conduit;
   wherein the system further comprises a closed fluid conduit configured to transport heat transfer fluid to the terminal end of the wellbore and return the heat transfer fluid heated at the terminal end of the wellbore back to the surface without releasing the heat transfer fluid into the wellbore;
   wherein a first portion of the plurality of manufactured gravel pieces contacts an inner surface of the wellbore, while a second portion of the plurality of manufactured gravel pieces contacts an outer surface of the closed fluid conduit, thereby stabilizing the inner surface of the wellbore that is contacted by the first portion of the plurality of manufactured gravel pieces and facilitating increased heat transfer between the inner surface of the wellbore and the outer surface of the closed fluid conduit;
   wherein the wellbore comprises a second heat transfer fluid (e.g., wherein the second heat transfer fluid is a eutectic salt, an ionic liquid, a nanofluid, or an oil);
   wherein each of the plurality of manufactured gravel pieces comprises a first approximately hemispherical end part that is connected to a second approximately hemispherical end part by a connecting rod;
   wherein a length of the connecting rod is less than a diameter of the first and second approximately hemispherical end parts, such that the first approximately hemispherical end part of one manufactured gravel piece fits within a space between the first and second approximately hemispherical end parts of another manufactured gravel piece;
   wherein each of the plurality of manufactured gravel pieces comprises:
four approximately hemispherical end parts; and
four connecting rods, wherein each connecting rod of the four connecting rods is coupled at one end to a corresponding approximately hemispherical end part of the four approximately hemispherical end parts, and is coupled at another end to wherein for each of the four approximately hemispherical end parts, a corresponding connecting rod, wherein the connecting rods are joined at a central point;
   wherein each of the plurality of manufactured gravel pieces comprises:
a central rod (e.g., approximately cylindrical or cylindrical with a tapered diameter) extending along a vertical direction;
a plurality of support rods, each of the support rods connected along an outer circumference of the central rod at a position along a length of the central rod (e.g., wherein each of the plurality of support rods is directed along a plane normal to the vertical direction of the central rod, e.g., wherein each of the plurality of support rods extends along the plane at an angle relative to an adjacent support rod); and
for each support rod of the plurality of support rods, a corresponding rounded part extending in an arc from a top end of the central rod to a bottom end of the central rod and connected at a central point to an end of the support rod;
   wherein each of the plurality of manufactured gravel pieces comprises a rectangular piece twisted along a central plane of the rectangular piece (e.g., wherein it is twisted at an angle of at least 90 degrees);
   wherein the plurality of manufactured gravel pieces comprises a plurality of connected links, wherein each link comprises one or more (e.g., approximately circular or oval) openings (e.g., wherein each link comprises an opening oriented at an angle relative to a direction of an adjacent opening).

Embodiment 2. A manufactured gravel piece for fortifying a wellbore extending into the Earth (e.g., from a surface to a terminal end within an underground magma reservoir), the manufactured gravel piece sized and shaped to aid in preventing collapse of the wellbore at least in a reinforced volume in which a plurality of the manufactured gravel pieces are placed.
wherein the manufactured gravel piece further comprises:
a first approximately hemispherical end part;
a second approximately hemispherical end part; and
a connecting rod coupled to the first and second approximately hemispherical end parts;
   wherein a length of the connecting rod is less than a diameter of the first and second approximately hemispherical end parts, such that the first approximately hemispherical end part of the manufactured gravel piece fits within a space between the first and second approximately hemispherical end parts of another manufactured gravel piece;
   wherein the manufactured gravel piece further comprises:
four approximately hemispherical end parts; and
four connecting rods, wherein each connecting rod of the four connecting rods is coupled at one end to a corresponding approximately hemispherical end part of the four approximately hemispherical end parts, and is coupled at another end to wherein for each of the four approximately hemispherical end parts, a corresponding connecting rod, wherein the connecting rods are joined at a central point;
   wherein the manufactured gravel piece further comprises:
a central rod (e.g., approximately cylindrical or cylindrical with a tapered diameter) extending along a vertical direction;
a plurality of support rods, each of the support rods connected along an outer circumference of the central rod at a position along a length of the central rod (e.g., wherein each of the plurality of support rods is directed along a plane normal to the vertical direction of the central rod, e.g., wherein each of the plurality of support rods extends along the plane at an angle relative to an adjacent support rod); and
for each support rod of the plurality of support rods, a corresponding rounded part extending in an arc from a top end of the central rod to a bottom end of the central rod and connected at a central point to an end of the support rod;
   wherein the manufactured gravel piece further comprises a rectangular piece twisted along a central plane of the rectangular piece (e.g., wherein it is twisted at an angle of at least 90 degrees); and
   wherein the manufactured gravel piece further comprises a link with one or more (e.g., approximately circular or oval) openings (wherein the link comprises an opening oriented at an angle relative to a direction of an adjacent opening).

This disclosure describes example systems that may facilitate improved geothermal operations. While these example systems are described as employing heating through thermal contact with a magma reservoir 214, it should be understood that this disclosure also encompasses similar systems in which another thermal reservoir or heat source is harnessed. For example, heat transfer fluid may be heated by underground water at an elevated temperature. As another example, heat transfer fluid may be heated by radioactive material emitting thermal energy underground or at or near the surface. As yet another example, heat transfer fluid may be heated by lava, for example, in a lava lake or other formation. As such, the magma reservoir 214 of FIGS. 3-7 may be any thermal reservoir or heat source that is capable of heating heat transfer fluid to achieve desired properties (e.g., of temperature and pressure). Furthermore, the thermal reservoir or heat source may be naturally occurring or artificially created (e.g., by introducing heat underground that can be harnessed at a later time for energy generation or other thermal processes.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. Moreover, items shown or discussed as coupled or directly coupled or communicating with each other may be indirectly coupled or communicating through some interface device, or intermediate component whether electrically, mechanically, fluidically, or otherwise.

While this disclosure has been particularly shown and described with reference to preferred or example embodiments, it will be understood by those skilled in the art that various changes in form and detail may be made therein without departing from the spirit and scope of the disclosure. Accordingly, this disclosure includes all modifications and equivalents of the subject matter recited in the claims appended hereto as permitted by applicable law. Changes, substitutions, and alterations are ascertainable by one skilled in the art and could be made without departing from the spirit and scope disclosed herein. Moreover, any combination of the above-described elements in all possible variations thereof is encompassed by the disclosure unless otherwise indicated herein or otherwise clearly contradicted by context.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

We claim:

1. A system, comprising:
a wellbore extending from a surface to a terminal end within an underground magma reservoir; and
a plurality of manufactured gravel pieces positioned within the wellbore for form a reinforced volume, the plurality of manufactured gravel pieces configured to aid in preventing collapse of the wellbore at least in the reinforced volume.

2. The system of claim 1, wherein the wellbore is an uncased wellbore.

3. The system of claim 1, wherein each of the manufactured gravel pieces is configured to interlock with another of the manufactured gravel pieces, such that the manufactured gravel pieces form an interlocked structure within the wellbore.

4. The system of claim 3, wherein the interlocked structure forms an empty volume within the reinforced volume through which fluid can flow.

5. The system of claim 1, wherein at least a portion of the plurality of manufactured gravel pieces are located at the terminal end of the wellbore within the magma reservoir.

6. The system of claim 1, further comprising a permeable packer positioned at a position above the terminal end of the wellbore and configured to hold at least a portion of the plurality of manufactured gravel pieces in place above the permeable packer, while allowing a flow of fluid through the permeable packer.

7. The system of claim 1, wherein each of the plurality of manufactured gravel pieces is formed of a heat conducting material.

8. The system of claim 7, wherein a portion of the plurality of manufactured gravel pieces contact an inner surface of the wellbore, thereby facilitating increased heat transfer with the magma reservoir.

9. The system of claim 1, further comprising an open fluid conduit configured to transport heat transfer fluid to a position proximate the terminal end of the wellbore and release the heat transfer fluid into the wellbore.

10. The system of claim 9, wherein a first portion of the plurality of manufactured gravel pieces contacts an inner surface of the wellbore, while a second portion of the plurality of manufactured gravel pieces contacts an outer surface of the open fluid conduit, thereby stabilizing the inner surface of the wellbore that is contacted by the first portion of the plurality of manufactured gravel pieces and facilitating increased heat transfer between the inner surface of the wellbore and the outer surface of the open fluid conduit.

11. The system of claim 1, further comprising a closed fluid conduit configured to transport heat transfer fluid to the terminal end of the wellbore and return the heat transfer fluid heated at the terminal end of the wellbore back to the surface without releasing the heat transfer fluid into the wellbore.

12. The system of claim 11, wherein a first portion of the plurality of manufactured gravel pieces contacts an inner surface of the wellbore, while a second portion of the plurality of manufactured gravel pieces contacts an outer surface of the closed fluid conduit, thereby stabilizing the inner surface of the wellbore that is contacted by the first portion of the plurality of manufactured gravel pieces and facilitating increased heat transfer between the inner surface of the wellbore and the outer surface of the closed fluid conduit.

13. The system of claim 11, wherein the wellbore comprises a second heat transfer fluid.

14. The system of claim 13, wherein the second heat transfer fluid comprises one or more of a eutectic salt, an ionic liquid, a nanofluid, or an oil.

15. The system of claim 1, wherein each of the plurality of manufactured gravel pieces comprises a first approximately hemispherical end part that is connected to a second approximately hemispherical end part by a connecting rod.

16. The system of claim 15, wherein a length of the connecting rod is less than a diameter of the first and second approximately hemispherical end parts, such that the first approximately hemispherical end part of one manufactured gravel piece fits within a space between the first and second approximately hemispherical end parts of another manufactured gravel piece.

17. The system of claim 1, wherein each of the plurality of manufactured gravel pieces comprises:
four approximately hemispherical end parts; and
four connecting rods, wherein each connecting rod of the four connecting rods is coupled at one end to a corresponding approximately hemispherical end part of the four approximately hemispherical end parts, and is coupled at another end to wherein for each of the four approximately hemispherical end parts, a corresponding connecting rod, wherein the connecting rods are joined at a central point.

18. The system of claim 1, wherein each of the plurality of manufactured gravel pieces comprises:
a central rod extending along a vertical direction;
a plurality of support rods, each of the support rods connected along an outer circumference of the central rod at a position along a length of the central rod, wherein each of the plurality of support rods is directed along a plane normal to the vertical direction of the central rod, wherein each of the plurality of support rods extends along the plane at an angle relative to an adjacent support rod; and
for each support rod of the plurality of support rods, a corresponding rounded part extending in an arc from a top end of the central rod to a bottom end of the central rod and connected at a central point to an end of the support rod.

19. The system of claim 1, wherein each of the plurality of manufactured gravel pieces comprises a rectangular piece twisted along a central plane of the rectangular piece.

20. The system of claim 1, wherein the plurality of manufactured gravel pieces comprises a plurality of connected links, wherein each link comprises one or more openings; wherein each link comprises an opening oriented at an angle relative to a direction of an adjacent opening.
